(19) United States
(12) Patent Application Publication
(10) Pub. No.: US 2024/0384932 A1
(43) Pub. Date: Nov. 21, 2024

(54) DRYER WITH A CONVEYOR SYSTEM FOR CONVEYING BOARDS TO BE DRIED

(71) Applicant: GRENZEBACH BSH GMBH, Bad Hersfeld (DE)

(72) Inventors: Volker GRESS, Bad Hersfeld (DE); Fabian GREB, Haunetal-Wehrda (DE)

(73) Assignee: GRENZEBACH BSH GMBH, Bad Hersfeld (DE)

(21) Appl. No.: 18/689,941

(22) PCT Filed: Sep. 11, 2022
(86) PCT No.: PCT/EP2022/025423

§ 371 Date: Mar. 7, 2024

(30) Foreign Application Priority Data
Sep. 11, 2021 (DE) 10 2021 004 585.8

(51) Int. Cl. F26B 15/18; F26B 25/02

(52) U.S. Cl. CPC F26B 15/18; F26B 25/02

(57) ABSTRACT

A dryer with a conveyor system with a plurality of sections extending one behind the other in the conveying direction for conveying passing boards to be dried in a plurality of levels per section with conveying devices arranged in levels in the form of roller conveyors, with a drive system, including a plurality of endless chains, each chain being assigned at least one drive, is characterized in that the roller conveyors of all the levels of a respective section can be driven by at least one single chain in each case, which engages over the levels of the respective section.

The invention relates to a dryer with a conveyor system for conveying boards to be dried according to the general term of claim 1.

By means of a conveyor system, boards to be dried, for example plasterboard, veneer boards, wood fiber, mineral wool, rock wool or glass wool boards, are conveyed through a dryer. Plasterboard essentially consists of a gypsum core, which is covered with cardboard on the surface and longitudinal sides. A cardboard surface (top and bottom cardboard) attached to the top and bottom of the gypsum core is glued together.

EP 1 232 371 B1 discloses a dryer according to the general term of claim 1. This dryer has conveying devices arranged in levels, each conveying device being designed as a roller conveyor. The drive system consists of a plurality of endless chains.

The dryer consists, for example, of drying chambers, fields or sections of the same length, which are repeated in the dryer in a similar or identical manner in the throughput direction of the plates. The dryer is a continuous dryer which the boards, in particular the plasterboard boards, leave as dried boards after passing through it.

DE 10 2009 059 822 B4 discloses a dryer for drying boards in which the boards are guided through the drying chambers in levels, the boards being brought into contact with drying air by means of impingement jet ventilation and the impingement jet ventilation being ensured by means of cross-ventilated nozzle boxes.

In the low-temperature range, i.e. at temperatures of 150° C. or less, in particular at temperatures below 100° C., nozzle boxes for targeted impingement jet ventilation are not required because there is no risk of uneven drying and the boards cannot be damaged by uneven drying at these temperatures. For this reason, the use of nozzle boxes in a low-temperature dryer is not necessary; it is sufficient to ventilate the boards to be dried with warm air in the longitudinal or transverse direction.

The advantage of low-temperature drying is that it can preferably be combined with heat exchangers or other concepts for utilizing the warm air. Low-temperature drying is often implemented in conjunction with environmentally friendly or energy-saving measures. The reason for this is that the low temperatures mean that low-calorific heat sources can be used to generate energy. Examples of this are solar collectors or process exhaust air from other plant components, which are used very efficiently in this area.

Wall boards in particular are suitable for low-temperature drying. In this application, the dryer is cross-ventilated as standard. Flat boards, for example plasterboard, are dried horizontally.

The task of the invention is to create a compact conveyor system for a low-temperature dryer.

According to the invention, this task is solved as stated in patent claim 1.

Due to the drying time of the boards to be dried, in particular the gypsum plasterboards, being several times longer, the invention creates a system for drying the gypsum plasterboards by means of which a larger number of gypsum plasterboards per room unit can be dried and transported compared to the prior art.

For this purpose, a drive system is created which is adapted to a dryer operating at low temperature and to the large number of boards, in particular plasterboard boards, which are simultaneously processed in the low-temperature dryer over a large number of shelves, for example forty to sixty shelves.

By using a high number of shelves in conjunction with the drive system according to the invention, a longer dwell time of the boards, in particular the plasterboard, can be realized in a low-temperature dryer with the same dryer length as in a high-temperature dryer.

Advantageous further embodiments of the invention can be seen from the sub-claims and the description, in particular in conjunction with the drawings.

An advantageous embodiment of the dryer is one in which, in the case of a single chain, this chain overlaps the shelves of the respective section in a zigzag or meandering manner.

Each chain is equipped with at least one drive motor; in the case of a long chain length, two or more drive motors can be provided, as is known from EP 1 232 371 B1

In a further advantageous embodiment, if there is a plurality of chains per section of the dryer, two support rollers lying next to each other on a level are each driven by a single chain spanning the levels.

Preferably, the chains are electronically synchronized with each other for each section—and also preferably over the entire length of the dryer, for example via a radio communication, for example according to the master-slave principle or by means of an incremental encoder; preferably, motors with frequency converters are used; alternatively, the chains are driven together via a master chain.

It is advantageous if the master chain is driven by at least one drive motor.

It is also advantageous if the chains are guided via chain guide rails.

If the dryer is used as a low-temperature dryer at temperatures below 150° C., the idlers are supported by roller bearings. Graphite-based plain bearings are not required for high-temperature dryers. In addition, roller bearings have lower coefficients of friction than plain bearings. The idler roller is preferably supported by internal roller bearings. In this case, the axle is stationary during operation and only the roller shell rotates together with the sprocket. Alternatively, the bearing can also be mounted outside the idler. In this case, flange bearing units must be used and the shaft must also rotate. If internal bearings are used, a continuous shaft must be used. Another variant is the use of shaft journals at both ends of the roller. In this case, the bearings are arranged externally, for example. However, it has been shown that the production of idlers with a continuous shaft is simpler. The greater amount of material required for the continuous shaft is of little consequence. For this reason, idlers with a continuous axle and internal bearings are preferably used according to the invention.

Preferably, the roller bearings are designed as ball bearings, deep groove ball bearings or needle roller and cage assemblies.

It is also advantageous if a chain tensioning device is arranged for each chain or at least each master chain.

Preferably, the chain tensioning device is mounted in a suspended manner.

In accordance with the invention, a roller conveyor is thus used, as it can be built very compactly. As a result, horizontal transportation of the boards to be dried with the aid of a roller conveyor using driven idlers is suitable.

Idlers with the smallest possible diameter are therefore preferred. Idlers with internal bearings and a continuous axle, in particular with a bearing with deep groove ball bearings, are particularly preferred.

In order to rotate all idlers evenly, the power must be transferred from a central power source (motor, etc.) to all idlers. The chain drive is provided on one side of the idlers.

The invention is explained in more detail below using examples of embodiments. It shows

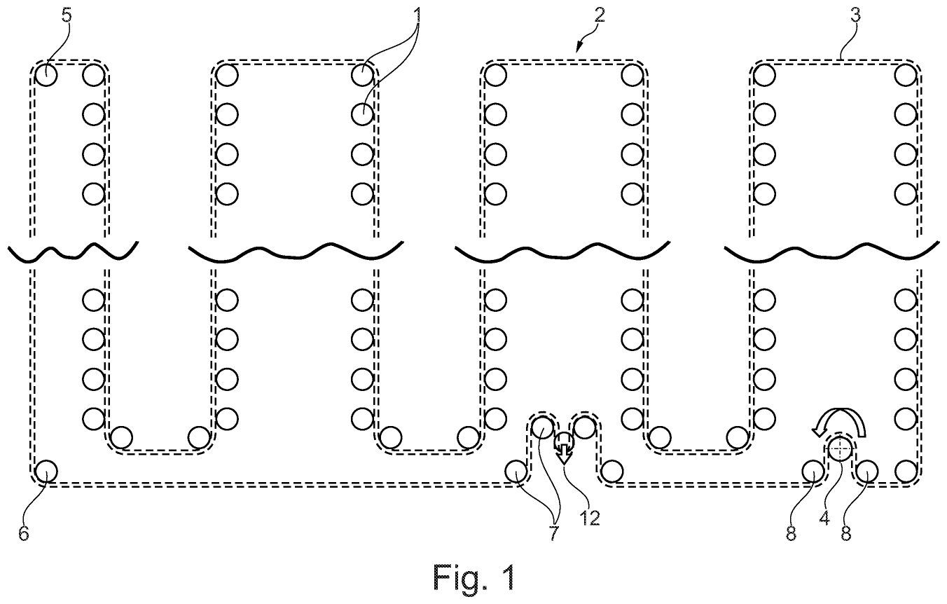

FIG. 1 a side view of a dryer section on the drive side, where the roller conveyors of the section are driven by a single chain,

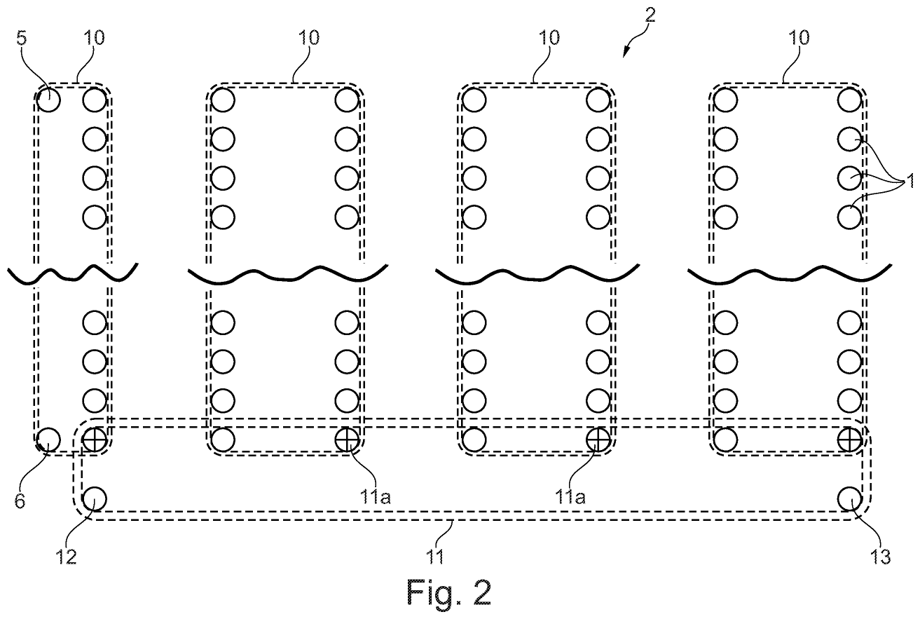

FIG. 2 a side view of a dryer section on the drive side, wherein the roller conveyors of the section are driven by a plurality of chains, which in turn are driven by a master chain, and

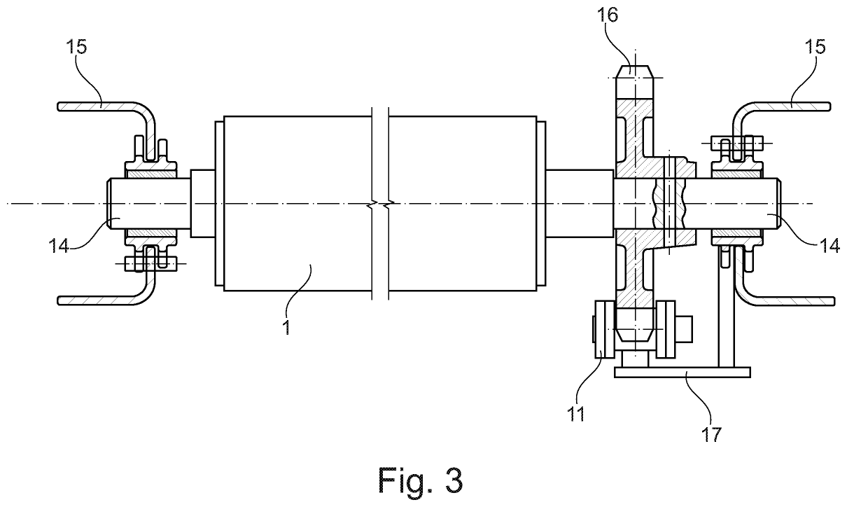

FIG. 3 shows the bearing of a roller of a roller conveyor in longitudinal section.

According to the invention, two alternatives are realized for chain guidance.

In a first variant, idlers 1 (FIG. 1) as roller conveyors of a complete section 2 of a dryer are each driven by a single chain 3 spanning all levels of the section 2 by means of a motor 4, which is preferably a geared motor. The chain 3 is also guided by deviating wheels 5 to 8. A tensioning device 9 is preferably provided in each chain 3 of the sections 3; an arrangement for lubricating the chain 3 is preferably also provided. The levels each extend above the idlers 1, which are at the same height.

In a second variant, the idlers 1 (FIG. 2) of a section 2 are driven by a plurality of chains 10. The power is transmitted by means of a master chain 11 to several chains 10 acting as output chains. Each of the chains 10 must be tensioned and lubricated individually; corresponding tensioning and lubricating devices (not shown here) are therefore provided. The master chain 11 is driven centrally by a single motor, for example a geared motor (not shown here). Both the chains 10 and the master chain 11 are deflected by deviating wheels 5, 6; 12, 13. Pairs of sprocket wheels 11a coupled to each other transmit the drive force of the master chain 11 to the chains 10.

In the embodiment shown in FIG. 2, the master chain 11 can be used and scaled either for just one section of the dryer or for a number of sections. This means that, if necessary, a larger master chain can be used to drive the output chains on several sections. In this case, fewer geared motors are required per dryer. The chain forces in the output chains and return sprocket wheels are relatively low.

In both variants as shown in FIG. 1 and FIG. 2, chain guide rails are used to keep the chains 3, 10, 11 on track.

In order to tension the chains 3, 10, 11, they each run, for example, over a chain wheel which is mounted loosely on an axle which can be moved in a slot extending in a vertical direction, whereby the chain 3, 10, 11 is tensioned by a weight hanging from the axle on both sides of the chain wheel. For example, a tensioning device is used, such as that known in EP 1 232 371 B1 and provided with the reference sign 12 in FIG. 1.

Each section of the low-temperature dryer is equipped with a steel frame as a supporting structure, which also supports the conveyor system. The supporting structure comprises, for example, several steel profiles as main beams and secondary beams. The supporting structure is in turn attached to a foundation.

According to the invention, in the event of a defect, in particular a blockage of the dryer with plasterboard, it is possible to remove the plasterboard in levels on the non-drive side of the dryer.

Preferably, the support rollers are mounted within one level of a section of the dryer in such a way that they have a fixed bearing on their drive side and a floating bearing on the non-drive side.

The roller conveyor according to the invention has, for example, forty levels, which have, for example, a levels spacing of up to 100 mm and are designed for two webs of boards to be dried conveyed side by side, although more webs of plasterboard can also be transported side by side at the same time in a correspondingly wider dryer. This results in a minimum dryer length of 25 sections, for example, which corresponds to a length of 60 m in order to achieve the required production output. One level of the roller conveyor, for example, consists of seven driven idlers on one level. The idlers have an outer diameter of 60 mm, for example; it is also not excluded that non-driven idlers may also be present between driven idlers. The idlers have a width that covers the entire width of the plates conveyed side by side and have a continuous axle and internal bearings. In addition, an axle support is preferably used in the middle.

All levels are attached in a fixed/floating bearing construction to supports provided for this purpose. Vertical beams made of folded sheet metal are used as supports on the drive side. These are attached to the main girders of the scaffolding via two further plates. Recesses in the form of keyholes (fixed bearings) are provided in the vertical beams. On the non-drive side, longitudinal beams are used in levels, which are attached to the main beams via slotted holes. Recesses are provided in the longitudinal beams into which the axles of the idlers can be inserted (floating bearings).

The roller conveyor is driven by a spur gear motor, for example. The geared motor transmits the power to a master chain, which in turn transmits the power to two output chains, for example. The output chains are chains that drive three or four rows of idlers, for example. The idlers are driven tangentially.

In another embodiment, the drives of several sections are driven by a master chain.

As can be seen in FIG. 3, the idlers 1 are provided with plugs 14 at their ends, which are rotatably mounted in roller carriers 15. On the drive side, a sprocket wheel 16 is located in front of the roller carriers 15 on each of the plugs 14. An endless chain 3 is guided over these sprocket wheels 16 in such a way that it simultaneously drives the rollers 1 of a larger number of levels. For this purpose, the chain 3 is guided via associated sprockets 16 in such a way that the chain 3 is supported, for example, by a plate 17 and a guide rail fixed to it.

1. A dryer with a conveyor system with a plurality of sections extending one behind the other in the conveying direction for conveying passing boards to be dried in a plurality of levels per section with conveying devices arranged in the levels in the form of roller conveyors, with a drive system, comprising a plurality of endless chains, at least one drive being assigned to each chain, wherein, the roller conveyors of all the levels of a respective section can be driven by at least one single chain which engages over the levels of the respective section.

2. The dryer according to claim 1, wherein, in the case of a single chain per section or for a plurality of sections, this chain engages over the levels of the respective section or of the plurality of sections in a zigzag or meandering manner.

3. The dryer according to claim 2, wherein the chain is equipped with at least one drive motor.

4. The dryer according to claim 1, wherein, in the case of a plurality of chains per section, two support rollers lying next to one another on a level can be driven in each case by a single chain spanning the levels.

5. The dryer according to claim 3, wherein the chains per section can be synchronized with one another by a radio communication or in that the chains can be driven together via a master chain.

6. The dryer according to claim 5, wherein the mother chain is driven via at least one drive motor.

7. The dryer according to claim 1, wherein the chains are guided via chain slide rails.

8. The dryer according to claim 1, wherein the dryer can be used as a low-temperature dryer at temperatures below 150° C. and in that the support rollers are mounted via roller bearings.

9. The dryer according to claim 8, wherein the rolling bearings are designed as ball bearings, deep groove ball bearings or needle roller and cage bearings.

10. The dryer according to claim 1, wherein a chain tensioning device is arranged for each chain or at least for each master chain.

11. The dryer according to claim 1, wherein the chain tensioning device is mounted in a suspended manner.
